(19) United States
(12) Patent Application Publication
(10) Pub. No.: US 2006/0285730 A1
(43) Pub. Date: Dec. 21, 2006

(54) Method a device and a computer program arranged to develop and execute an executable template of an image processing protocol

(75) Inventors: Raymond Joseph Elisabeth Habets, Eindhoven (NL); Rutger Nijlunsing, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., EINDHOVEN (NL)

(21) Appl. No.: 10/569,019

(22) PCT Filed: Aug. 18, 2004
(86) PCT No.: PCT/IB04/51477

§ 371 Date: Feb. 23, 2006

(30) Foreign Application Priority Data
Aug. 29, 2003 (EP) 03103244.4

(51) Int. Cl. G06K 9/00

(52) U.S. Cl. 382/128

(57) ABSTRACT

In a method for use in a medical environment, which is designed to develop an executable template of an image processing protocol (21), a user at step (22) selects and loads a reference image, on which at step (24) the user defines all necessary reference marks together with necessary image handling operations by means of an interactive protocol editor arranged to operate in a geometrical relational application framework macro. The actions carried out by the user for purposes of template development are logged as corresponding entries in the protocol. Upon completion of the template development, the template is tested at step (26) and is stored at step (28). A method (30) for use in a medical environment to carry out a customized image handling process comprises the steps of loading a template from a list of pre-defined templates at step (32), carrying out necessary customization operations at step (33), executing the template at step (36). The image processing protocol prompts the user at step (38) to define the actual marks for the actual image, and creates the actual graphical overlay on the actual image at step (40) upon completion of the marks definition. The invention further relates to a device, a computer program and a medical examination apparatus arranged for carrying out the methods according to the invention.

The invention relates to a method, particularly for use in a medical environment, to develop an executable template of an image processing protocol.

The invention further relates to a device arranged to carry out the steps of the method to develop an executable template of an image processing protocol.

The invention still further relates to a computer program arranged to carry out the steps of the method to develop an executable template of an image processing protocol.

The invention still further relates to a computer program, arranged particularly for use in a medical environment, to carry out automated customized image handling.

The invention still further relates to a device arranged to carry out the steps of the method to carry out the automated customized image handling operation.

The invention still further relates to a medical examination apparatus.

An embodiment of a method arranged to interactively construct and manipulate relational geometric objects is known from WO/0063844. The known method is arranged to provide detailed descriptions of the various objects defined within an image comprising medical data, in particular to structurally interrelate said objects within the geometry of the image, thus providing structural handling of various geometrical objects so that a certain geometrical consistency within the objects is maintained during a manipulation of the image. The known method is applicable in a field of medical image processing, where an expert handling and analysis of the image is required. Suitable images can be provided by a plurality of medical instruments, for example single and multiple shot X-ray images, computer tomography, magnetic resonance images, ultrasound acquisitions and other suitable image acquisition modalities. Subsequent medical procedures that are based on those images require prior detailed knowledge of the image data, for example information about a spatial relation between the objects in said images, the relative and/or absolute dimensions of the objects and other image handling comprising drawing supplementary objects for reference purposes.

It is a disadvantage of the known method that a predefined set of relational geometric objects accommodatable for the geometry of a new image is created, said set resulting in a given graphical overlay. In the case where the given graphical overlay has to be changed by the user, the known method provides limited means for enabling a necessary change.

It is an object of the invention to provide a method with an improved user-friendliness, wherein the image handling is definable in an interactive graphic way, which can be tailored in an easy fashion to suit requirements and demands of versatile users.

For this purpose, the method as set forth in the opening paragraph comprises the steps of:

creating a set of anatomical marks in an image, said marks having respective associated image positions;

combining said marks to form geometric objects;

defining a sequence of operations with said geometric objects by means of an interactive protocol editor, wherein each operation is logged as an entry in a geometrical relational application framework macro;

storing said sequence of operations in said template.

The technical measure of the invention is based on the following insights. Most medical workstations and medical applications designed for image handling and image processing offer a standard image handling tool, for example a standard measurement tool. Clinical applications, however, require complex image handling, which cannot be envisaged in the standard handling tool. With the relational geometric toolbox, wherein the objects are defined within the image, a complex image handling tool can be constructed on a conceptual level by creating an integrated development environment comprising both a geometrical relational application framework and an interactive protocol editor. When a template is under construction, an expert, who may be a medical specialist, an imaging specialist, a radiographer or a technician, say, defines the necessary geometrical objects within a reference medical image followed by a definition of the image handling steps necessary to carry-out certain image handling. The conceptual steps of the said image handling are logged in the template for any predefined or existing image processing protocol together with the corresponding relational geometry between the defined objects. When an actual image is selected for a same type of image handling, the specialist, or any other suitable person can load the pre-stored conceptual template, define the marks corresponding to the actual image and execute the template. Preferably, the template is pre-stored in an ASCI format. During execution of the template the geometrical relations between the pre-defined objects in the image are automatically matched to the user-defined marks on the actual image. Due to the fact that the image handling protocol is defined within a geometrical relational application framework, the protocol steps are tailored to the position and geometry of the actual image. It must be noted that the term marks is not limited to a point, but can comprise a two-dimensional area or a three-dimensional volume. Therefore, it is easy to carry out the image handling by means of the executable template according to the invention, wherein the building blocks of the integrated environment can be tuned to the user's area of expertise, thus yielding a versatile and flexible image handling tool.

In an embodiment of the method according to the invention for creating a set of anatomical marks an interactive graphical toolbox is provided for purposes of defining the associated image positions. It is found to be advantageous to provide an interactive graphical toolbox comprising a plurality of predefined geometrical objects and reference marks for purposes of creating a set of anatomical marks. It must be noted that the term image position comprises a volume position, which can be determined from the raw data or by means of suitable rendering techniques, known per se in the art. Any suitable graphical toolbox as per se known from the art of computer graphics can be used for this purpose. The user can enter the necessary marks by means of a suitable interface, like a mouse, a graphical tabletop, a monitor pointer or by any other suitable means including downloading a set of coordinates of the marks from a file.

In a further embodiment of the method according to the invention, a process of creating a set of anatomical marks is performed automatically based on pixel values of an area of interest within the image. It is found to be particularly advantageous to extract the position of the anatomical marks automatically from the image data based on the pixel value of the area of interest. For instance, in orthopedic applications, the surgical manipulation of a joint, say, the position of the joint, for example the femur head, can be automatically delineated based on the contrast of the bone with respect to surrounding soft tissue. A plurality of suitable algorithms of an edge detection, gradient analysis or shape models known per se in the art of image processing can be used for this purpose.

In a still further embodiment of the method according to the invention a location of the area of interest is determined from a pre-stored look-up table comprising image coordinates of the area of interest corresponding to a type of the image processing protocol selected for said image. In the case of poor contrast within the image it is possible to locate the sought mark position from the list of pre-stored coordinates, for example, in the case in which the image processing protocol in use concerns a specific surgical procedure on a joint, a position of the joint, say, can be ascribed a most likely position as is pre-stored in a respective look-up table. Provided the medical images are taken with a consistent patient geometry setup this approach is particularly useful, thus providing an educated guess of the mark positions. The user can then alter the position of the mark in case he detects a discrepancy between the image data and the automatic position of the marks.

In a still further embodiment of the method according to the invention a location of the area of interest is determined from a further look-up table arranged to store a plurality of linkings of the area of interest to reference objects within the image. In case the image already comprises some reference objects, it is possible to a-priori define a position of the area of interest with respect to said reference objects. The area of interest can then be overlaid on the image using the further look-up table. The position of the corresponding marks is then determined by means of a pixel value analysis within the thus located area of interest.

In a still further embodiment of the method according to the invention the step of combining said marks to form geometric objects is performed by means of an interactive graphical editor. Preferably, a suitable graphic tools panel is used for purposes of forming geometric objects from the marks. For instance, the graphic tools panel comprises a drawing tool like, line, circle, ellipse, sphere, cylinder, cube, mesh, intersection, volume together with relations like distances, angles, ratios, parallel to, perpendicular to, and constraints like greater than, smaller than and equal to, thus yielding a building block which is then addressed by the protocol of the template.

In a still further embodiment of the method according to the invention, for defining a sequence of operations with said geometric objects by means of an interactive editor use is made of a set of connected graphical toolkit blocks. In this way a relation is defined between the objects based on the marks within the image. The objects may have one, two or a plurality of dimensions. The complete set of objects represents a toolkit, including functions for measurements, analysis, construction operations and other suitable image handling. The relations between objects may be purely geometrical, thus defining their spatial interrelations. Alternatively, such relations may follow from a more complex formalism, like fixing or optimizing a distance and the like. The toolkit preferably comprises various tool types that may be elementary or compound in nature. In the latter case the tools can be derived from a set of various objects provided with primitive types and other derivative types. Each object has a geometrical representation that may depend on the image type on which the object is to be superimposed, or alternatively it can be tailored to user's preferences.

The device according to the invention comprises:

means for creating a set of anatomical marks in an image, said marks having respective associated image positions;

means for combining said marks to form geometric objects;

means for defining a sequence of operations with said geometric objects, wherein each operation is logged as an entry in a geometrical relational application framework macro;

means for storing said sequence of operations in said template.

Preferably, means for creating a set of anatomical marks in the image comprises a suitable graphical input means, like a mouse, a graphic tabletop, a pointer or any other suitable input media. In an alternative setup means for creating a set of anatomical marks comprises a suitable image processing algorithm arranged for delineating areas according to a pixel value distribution within a selected area of interest. Suitable image processing algorithms are known per se in the art, examples being an edge detection algorithm, a gradient analysis, suitable shape models, etc. Preferably, means for defining a sequence of operations with said geometric objects comprise an interactive protocol editor. An example of suitable means for storing said sequence of operations in said template is a database.

A computer program arranged particularly for use in a medical environment to carry out an automated customized image handling according to the invention comprises:

means for selecting a pre-stored template of an image processing protocol from a plurality of pre-stored templates, said template comprising a sequence of operations with a plurality of reference geometrical objects, said sequence being logged as a plurality of instructions within a geometrical relational application framework macro, said objects being defined for a plurality of reference marks;

means for entering a plurality of actual marks for an actual image;

means for constructing actual geometrical objects for the actual image by means of referencing the actual marks to the reference marks;

means for executing the sequence of operations on the actual geometrical objects.

Preferably, the computer program is arranged to operate a user-interface comprising suitable fields where the user can select or define necessary operations. An example of a suitable user-interface will be discussed with reference to Fig. lb.

These and other aspects of the invention will be discussed in further detail with reference to the Figures.

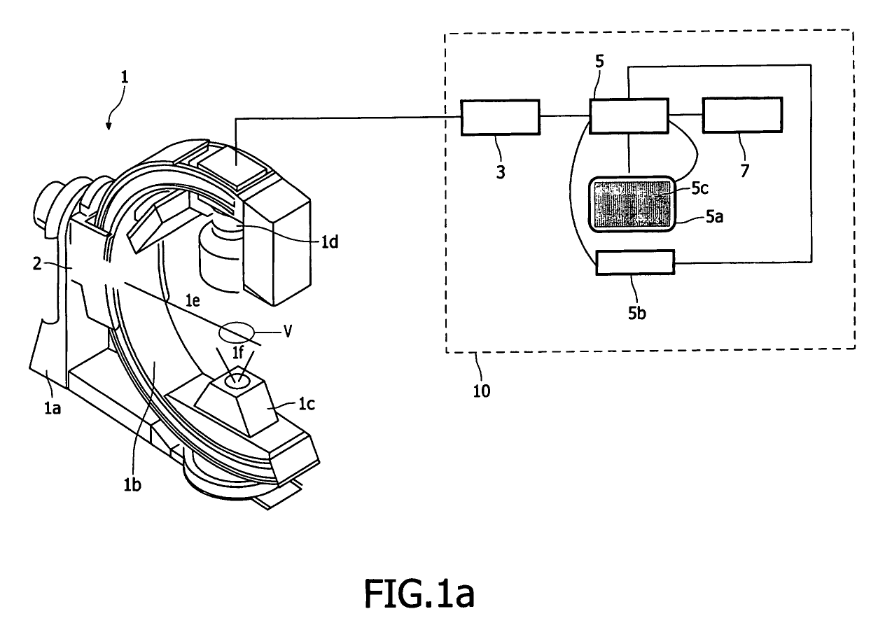

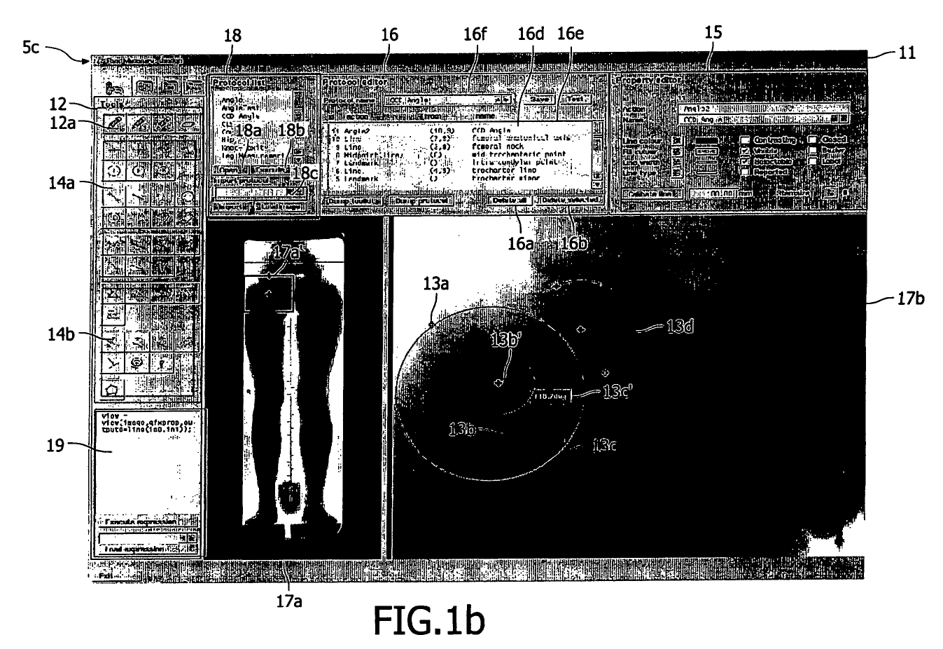

FIG. 1a presents a schematic view of an embodiment of a device according to the invention.

FIG. 1b presents an embodiment of a user interface.

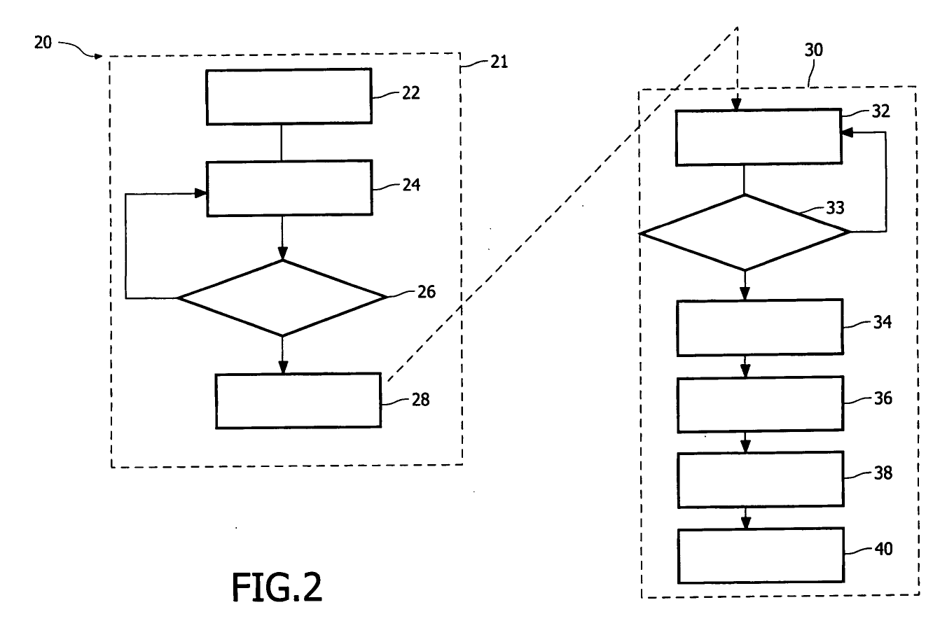

FIG. 2 presents a schematic view of an embodiment of a workflow corresponding to the method particularly for use in a medical environment to develop and execute an executable template of an image processing protocol according to the invention.

FIG. 1 presents a schematic view of an embodiment of an assembly comprising a device according to the invention. The assembly I comprises an image acquisition system 2 arranged to communicate acquisition data to the device 10 for further processing. In the current embodiment, by way of example an X-ray system is shown as a suitable image acquisition system 2. However, other modalities, like a magnetic resonance apparatus, an ultra-sound unit or any other suitable medical data acquisition modality can be used as the acquisition system 2. The X-ray apparatus 2 is arranged to generate a beam of X-rays 1f propagating from an X-ray source 1c. In order to obtain image data a patient (not shown) is placed in an acquisition volume V, located between the X-ray source 1c and the X-ray detector 1d, where a transmission image is formed. In order to obtain the transmission image with a given orientation, the X-ray source 1c together with the X-ray detector 1d can be rotated about the acquisition volume V about a rotation axis 1e. This rotation is enabled by the movement of the gantry 1a, which is usually rotatably mounted on a suitable gantry support means. The transmission images are forwarded to the device 10, where a primary image processing is carried out at image processing means 3. The primary image processing for example may comprise various types of image enhancement, image reconstruction and other suitable image processing techniques. The resulting transmission images are stored in a memory unit 7 as a suitably logged entry in a suitable database. When the image is selected for purposes of developing an executable template for an image processing protocol or for purposes of executing such a template, the image is loaded into a dedicated computer unit 5 and is presented to the user on the computer monitor 5a. The user can carry out the suitable image processing operation through an appropriate user interface 5c by means of a suitable input device 5b, like a keyboard, a computer mouse, a graphical tabletop are any other suitable input data medium, including a file reader. An example of a suitable user interface is given in more detail in FIG. 1b.

FIG. 1b presents an example of an embodiment of a user interface 5c. The user interface 5c comprises an interactive window 11, preferably divided into working fields 12, 14a,14b,15,16,17a,17b,18,19. The working field 12 comprises means for creating a set of anatomical marks in the image, which is presented in fields 17a as an overview image, where an area of interest 17a′ is selected. The area of interest is then presented to the user in the further working field 17b with a proper enlargement. In order to create a set of marks, for example a point 13a, or a line 13b, 13b′ in the image 17b a graphical toolbox 12 is provided. The graphical toolbox 12 comprises means of a type 12a for creating a set of anatomical marks in the image. Preferably, means of the type 12a correspond to actuatable buttons which upon selection enable the user to place marks 13a, 13b and create new shapes, like circles 13c, 13d in the image. Alternatively, instead of providing a dedicated button for each action, use can be made of a context sensitive pop-up menu, for example by means of activating a right mouse button. The context sensitive pop-up menu shows the actions that can be created with currently selected elements in the image. The graphical toolbox 12 further comprises means 14a, 14b arranged for combining the marks 13a, 13b, 13b′ and the like to form geometric objects, said means being defined as a set of actuatable buttons which correspond to a certain computer algorithm arranged to carry out a corresponding object formation. The means 14a,14b are also suited to carry out image handling, for example to determine a special relation between marks, like an angle between the lines 13b and 13b′, which is reported in the field 13c′. A plurality of suitable computer algorithms to enable the above functionality is known in the art of computer graphics. In principle, a button can create more than one object. For example, constructing a parallel line from a line and a mark will create the parallel line and an end point of that line, which in turn is a mark.

A combination of a set of objects selected by the user and a selection of a button is called an action. Each action corresponds to a single step in the image processing protocol, which is being logged in the working window 16 of the interactive protocol editor as an entry 16d in a geometrical relational application framework macro 16e. Alternatively, it is possible to add an expression editor where the user can define an action in a geometrical relational application framework expression language by suitable means 19. Erroneous entries can be deleted one by one by means of the delete button 16b, or all at once by activating a delete all button 16a. Upon completion of the template development in the working window 16, the resulting template for the image processing protocol is stored with a corresponding template identification 16f and can be accessed at a later instance by means of a selection of a corresponding entry in the working window 18, corresponding to the saved templates list. The templates list can be arranged to be offered to the user in the form of a drop down menu.

Preferably, the templates are shown which are applicable to the type of image shown on the screen and preferably also to the type of authorization held by the user. The working window 18 preferably comprises a template execute button 18a and a template open button 18b for user customization purposes. The functionality of each action is realized in a geometric relational application framework macro, as is set forth in the application WO 00/63844 in the name of the current Applicant. The selection of objects serves as an input for the geometric relational application framework macro. The outputs of said macro correspond to newly created objects or actions to be carried out with selected objects. By way of example a number of actions are set forth below.

One Mark Selected

1. The horizontal line button creates a horizontal line through the selected mark. By default the horizontal line will run across the entire image. Dragging the startpoint or the endpoint can alter the line length;

2. The vertical line button creates a vertical line through the selected mark. By default the vertical line will run across the entire image. Dragging the start point or the endpoint can alter the line length;

3. The circle button creates a circle centered at the selected mark. The circle border can be used to control the radius;

4. The circle & mark button creates a circle centered at the selected mark and a mark located at the circle's border. The border mark can be used to define the radius;

5. The ellipse & marks button creates an ellipse centered at the selected mark and three marks that control the ellipse's main axes and its width. The orientation of the ellipse can be altered with the two marks that form the main axes. The width of the ellipse can be changed with the third mark;

6. The offset button creates a mark relative to the selected mark;

7. The annotation button creates an annotation relative to the selected mark;

Two Marks Selected

8. The line button creates a line between the selected marks;

9. The extended line button creates a line ‘through’ the selected marks. For the generated line ‘through’ does not mean that the two selected marks have to be part of the line. The only restriction imposed is that the new line is part of the infinite line formed by the two selected marks;

10. The midpoint button creates a mark between the selected marks;

11. The border-circle button creates a circle for which the line between the selected marks is the circle's diameter;

12. The center-border circle button creates a circle for which the line between the selected marks is the circle's radius. The first of the two selected marks is used as the center;

13. The ellipse button creates an ellipse for which the line between the selected marks is the ellipse's main axis and a mark that controls the ellipse's width;

14. The rectangle button creates a rectangle for which the line between the selected marks is the rectangle's main axis and a mark that controls the rectangle's width;

15. The distance button creates a label indicating the distance between the selected marks and also draws a dotted double arrow line between these points;

One Line Selected

16. The midpoint button creates a mark halfway the selected line;

17. The bound-ruler button creates a mark that can move along the selected line. This mark is defined relative to the line (lambda); changing the line also changes the position of the mark;

18. The free-ruler button creates a mark that can move freely. This mark is defined relative to the line (lambda, distance);

19. The length button creates a label indicating the length of the selected line. If the label is repositioned a dotted single arrow line will appear and point to the line the label belongs to;

20. The perpendicular line button creates a perpendicular line through the selected line. By default this line will be centered at the selected line. Dragging the startpoint or the endpoint can alter the line length and dragging the entire line changes its position;

21. The endpoints button creates marks at both ends of the selected line; Two lines selected

22. The angle-arc button creates a label indicating the angle between the selected lines and also draws a dotted arc-line between these lines. Moving the label controls the radius of the arc. Optionally the arc can be replaced by two single arrow dotted lines that point from the angle label to the center of the corresponding lines;

23. The angle-label button creates a label indicating the angle between the selected lines and also draws two single arrow dotted lines from the angle label to the center of both lines;

24. The intersect button creates a mark at the intersection of the selected lines.

25. The line ratio button creates a label indicating the length ratio between the selected lines and also draws two dotted single arrow lines that point from the ratio label to the center of the corresponding lines;

26. The distance button creates a label indicating the distance between the selected parallel lines and also draws a dotted double arrow line perpendicular to both lines. In case the lines are not perpendicular the label displays the distance between the center of the first line and the second line.

One Mark and One Line Selected

27. The project button creates a mark that is the perpendicular projection from the selected mark onto the selected line;

28. The relative-position button creates a mark that is the perpendicular projection from the selected mark onto the selected line and creates a label that displays the relative position of that mark relative to the selected line (0% corresponds to the line start; 100% to the line end);

29. The distance button creates a label indicating the distance between the selected mark and line and also draws a perpendicular dotted double arrow line from the mark to the line;

30. The parallel line button creates a line parallel to the selected line starting at the selected mark;

31. The perpendicular line button creates a line perpendicular to the selected line starting at the selected mark;

32. The cup button creates a universal cup template centered at the selected mark. It also creates measurements of the ante version and inclination angles of the cup as well as its diameter. All angle measurements are reported relative to the selected line;

33. The stem button creates a stem-rasp template centered at the selected line relative to the selected mark (which is assumed to be the center of the corresponding cup).

For user's convenience, the working window 11 further comprises a property editor window 15, which provides additional tools for entering user-defined names for the macro outputs and to set color and line properties. The property editor can also be made available via a context sensitive pop-up menu. The property editor has two options to alter the appearance of contours. Contours can be closed or open and the interpolation can be set to straight lines or a bezier curve. If a stem-rasp template is selected the user can set the template size with the stem size control. The property editor allows the user to tailor the measuring tool to individual needs. The user can define the look and feel of all image handling tools, define names for all objects and compose a report. The resulting protocol and individual settings can be coupled to a specific user or a group of users. The property editor window preferably further comprises a reporting function (not shown). The reporting function allows the user to define a data handling result sheet, for example a measurement sheet. Each object will have its own reporting behavior. For example: a mark will report its position; an angle label will report its current angle value; a circle will report its center position and diameter. The resulting report can be displayed and exported to file or printer or hospital information system.

FIG. 2 presents a schematic view of an embodiment of a workflow corresponding to the method particularly for use in a medical environment to develop and execute an executable template of an image processing protocol according to the invention. The workflow 20 comprises a plurality of steps which can be divided into two sub-groups: first, a development stage 21 of the template for the image processing protocol, secondly an execution stage 30 for the template for the image processing protocol. It must be noted that in case a plurality of templates is developed by means of the development stage 21 it is not necessary for the purposes of the execution stage 30 to follow the development stage 21 again. In this case a saved template from a template list as discussed with reference to FIG. 1 b can be selected and executed.

The template development stage 21 comprises the following steps. First, at step 22 the user selects and loads a reference image, representative of a certain image processing protocol. For example for purposes of a measurement of a Collum Center Diaphysis angle, further referred to as a CCD-angle, an image of a lower extremity is selected, said image being obtained by means of a suitable medical imaging modality. At the next step 24 the user defines all necessary reference marks on the image, like points, lines, etc. as well as image handling operations, like drawing or measuring by means of the interactive protocol editor explained with reference to FIG. 1b. The protocol editor displays the actions in the order that the user performed them. Each line reports the selected action, a reference to the selected input objects and the names for the generated output objects.

Preferably, the protocol uses the following syntax:

[ID] [ACTION] [INPUTS] [OUTPUT NAMES]

[ID] The ID label represents the current number of the protocol step in the protocol. Protocol steps are numbered sequentially.

[ACTION] The ACTION label identifies the action selected by the user. The names of the actions correspond to the names of the buttons as presented in the previous section.

[INPUTS] The INPUTS label contains a list of inputs for the current action. The inputs are presented as IDs of the protocol step that provides the input along with an identifier that identifies the specific output of that protocol step (the latter may not visible).

[OUTPUT NAMES] The OUTPUT NAMES label identifies the user-selected names for each output of the protocol step. The default output names are output# with # the number of the output.

The protocol editor provides a field to enter a name for the created protocol. The user can select one or more steps from the protocol list using the mouse. If the corresponding graphic objects are visible and selectable they will be selected as well. The protocol editor has two buttons to delete protocol steps (just the selected steps or all steps). It also provides buttons to save and test the current protocol. After all necessary marks, provided with their respective names, are entered by the user the protocol is tested at step 26, and is saved at step 28 to be accessed at a later moment for execution purposes. The test option will preferably clear the image and then ask the user to enter each of the defined marks. As the user enters the marks all overlay graphics defined in the protocol will appear. For example, in case a template for measuring the CCD-angle is under development, the user carries-out the following procedures:

1. The user places a mark on the border of the femoral head near the upper rim of the acetabulum. The mark is drawn and the first action of the protocol is shown in the protocol edit box (I mark ( ) output0). The user can then name the mark (in this case: femoral head border) and set the properties for the mark.

2. The user places a mark on the border of the femoral head near the lower rim of the acetabulum. This mark is also called: femoral head border.

3. The user selects both femoral border points and clicks the border-circle button. This button creates a circle for which the line between the two selected points is used as the diameter. This circle is named femoral head.

4. The user selects both femoral border points and clicks the midpoint button. This point is named center of rotation.

5. The user places a mark at the most proximal point of the trochanter major. This mark is called: trochanter major.

6. The user places a mark at the center point of the trochanter major. This mark is called: trochanter minor.

7. The user selects both trochanter points and clicks the line button. This button creates a line that will be called trochanter line.

8. The user selects the trochanter line and clicks the midpoint button that defines a point at the middle of the line. This point is named mid-trochanteric point.

9. The user places a mark at the center of the femoral condyles. This mark is called: intra-articular point.

10. The user selects the center of rotation point and the mid-trochanteric point and clicks the line button. This button creates a line that will be called femoral head axis.

11. The user selects the mid-trochanteric point and the intra-articular point and clicks the line button. This button creates a line that will be called femoral anatomical axis.

12. The user selects the femoral head axis and the femoral anatomical axis and clicks the angle button. This button creates a label that prints the angle between the two selected lines. The labels will be called CCD angle.

At the template execution stage 30, the user at step 32 selects a suitable saved template from the list of available templates. At step 33 the user validates the image processing protocol steps by checking the entries in the interactive protocol editor. In case the user wants to customize the protocol steps or to amend the saved image processing protocol he can add or edit entries in the protocol steps list at step 33. In case the user is satisfied with the final image processing protocol, he moves to step 34 and selects an actual image to be processed. Subsequently, the user executes the selected template of the image processing protocol on the actual image at step 36. The template will prompt the user to enter the actual marks on the actual image. The user can enter the corresponding marks at step 38 by means of a suitable input device, like a computer mouse, a screen pointer, a graphical tabletop, etc. The mark can also be entered in an automatic fashion based on the pixel values of an area of interest. Delineation of objects can be carried out by means of a suitable edge detection algorithm, by means of a suitable gradient analysis, shape models, etc. Upon completion of the mark entering operation, the overlay graphics as defined by the selected image processing protocol will appear on the actual image at step 40. The overlay graphics may comprise a plurality of data handling operations, like carrying out measurement operations between the objects defined in the actual image, drawing guiding objects, like drilling tunnels for preparing orthopedic operations, etc. In order to provide quantitative results, the image processing protocol preferably comprises a calibration step. An example of a suitable calibration step comprises measuring absolute dimensions of a reference object with known dimensions in the actual image. For example, the user can enter a known dimension, for example a distance, and select a corresponding reference line in the actual image. Upon completion of the execution of the selected template, the results can be forwarded to a further unit for purposes of further analysis or archiving.

1. A method (21) particularly for use in a medical environment, to develop an executable template (16e) of an image processing protocol (18), said method comprising the steps of:
creating a set of anatomical marks (13a,13b) in an image (17b), said marks having respective associated image positions;
combining said marks (13a,13b) to form geometric objects (13c,13d);
defining a sequence of operations with said geometric objects by means of an interactive protocol editor (16), wherein each operation is logged as an entry (16d) in a geometrical relational application framework macro;
storing said sequence of operations in said template (16f).

2. A method according to claim 1, wherein for creating a set of anatomical marks an interactive graphical toolbox (12) is provided for purposes of defining the associated image positions.

3. A method according to claim 1, wherein the step of creating a set of anatomical marks is performed automatically based on pixel values of an area of interest (17a′) within the image.

4. A method according to claim 3, wherein a location of the area of interest (17a′) is determined from a pre-stored look-up table comprising image coordinates of the area of interest corresponding to a type of the image processing protocol for said image.

5. A method according to claim 3, wherein a location of the area of interest (17a′) is determined from a further look-up table arranged to store a plurality of linkings of the area of interest to reference objects within the image.

6. A method according to claim 1, wherein the step of combining said marks (13a,13b) to form geometric objects (13c,13d) is performed by means of an interactive graphical editor (14a).

7. A method according to claim 6, wherein each geometric object (13c) is assigned a directional linking to other objects (13d) to form relational geometric objects.

8. A method according to claim 1, wherein for defining a sequence of operations (16d) with said geometric objects by means of an interactive editor (16) use is made of a set of connected graphical toolkit blocks (12,14a,14b).

9. A method according to claim 1, wherein the operations are selected from a list of pre-stored operations (18).

10. A device (10) arranged to carry out the steps of the method according to claim 1, said device comprising:
means (12) for creating a set of anatomical marks (13a,13b) in an image (17b), said marks having respective associated image positions;
means (14a) for combining said marks to form geometric objects (13c,13d);
means (16) for defining a sequence of operations with said geometric objects by means of an interactive protocol editor, wherein each operation is logged as an entry (16d) in a geometrical relational application framework macro;
means (7,16f) for storing said sequence of operations in said template.

11. A medical examination apparatus (1) comprising the device according to claim 10.

12. A computer program arranged to carry out the steps of the method according to claim 1.

13. A computer program according to claim 12 comprising a user interface (5c) arranged to echo the steps of the method to the user.

14. A computer program particularly for use in a medical environment to carry out automated customized image handling, said computer program comprising:
means for selecting a pre-stored template (18) of an image processing protocol from a plurality of pre-stored templates, said template comprising a sequence of operations (16d) with a plurality of reference geometrical objects (13c,13d), said sequence being logged as a plurality of instructions within a geometrical relational application framework macro, said objects being defined for a plurality of reference marks (13a,13b);
means for entering a plurality of actual marks for an actual image;
means for constructing actual geometrical objects for the actual image by means of referencing the actual marks to the reference marks;
means for executing the sequence of operations on the actual geometrical objects.

15. A computer program according to claim 14, wherein means for the selecting of the pre-stored template is arranged to address a database (18) of templates.

16. A computer program according to claim 15, wherein the computer program further comprises:
means for customizing the sequence of operations on the actual geometrical objects by means of a connected graphical toolkit (12,14a,14b).

17. A computer program according to claim 14, wherein means for entering a plurality of actual marks comprises a graphical input device (5b,12).

18. A computer program according to claim 14, wherein said computer program comprises means for defining a position of an actual mark from a pixel value of an area of interest (17a′) within the actual image.

19. A computer program according to claim 14, wherein said computer program comprises a user interface (5c) arranged to interactively communicate to the user.

20. A device comprising a computer program according to claim 14.

21. A medical examination apparatus comprising the device according to claim 20.
